(19) United States
(12) Patent Application Publication
(10) Pub. No.: US 2003/0122274 A1
(43) Pub. Date: Jul. 3, 2003

(54) Method of producing foam glass for refractory thermal insulation material

(76) Inventor: Sang-Yoon Lee, Seoul (KR)

Correspondence Address: FOLEY AND LARDNER, SUITE 500, 3000 K STREET NW, WASHINGTON, DC, 20007, US

(21) Appl. No.: 10/276,249

(22) PCT Filed: Apr. 10, 2001
(86) PCT No.: PCT/KR01/00602

(30) Foreign Application Priority Data
May 16, 2000 (KR) 2000/26061
Mar. 28, 2001 (KR) 2001/16235

(51) Int. Cl. B27N 3/00

(52) U.S. Cl. 264/109

(57) ABSTRACT

A method of producing foam glass for refractory thermal insulation material in which a foam glass having a closed pore structure is produced by using porous silica gel so that heat resistance and corrosion resistance can be enhanced in a great amount. The method comprises the following steps of: preparing a silica gel according to a sol-gel method from alkali silicate which is obtained by fusing carbon dioxide and alkali; exposing the silica gel in the wet air to absorb a proper amount of moisture; inputting silica gel in a certain amount to a heat resistant mold(F) to be shaped; calcining the mold at a constant rate up to a temperature of 980 to 1300° C. by using a tunnel kiln or a shuttle kiln(K) to be heated at least the softening temperature of glass, whereby the silica gel is fused into a foam glass in a sol state; and cooling the fused foam glass.

### BACKGROUND OF THE INVENTION

1. Field of the Invention

The present invention relates to a method of producing foam glass for refractory thermal insulation material, in particular, in which foam glass having a closed pore structure is produced by using porous silica gel so that heat resistance and corrosion resistance thereof can be enhanced in a great amount.

2. Description of the Related Art

In general, the refractory thermal insulation material for construction which is manufactured by mixing rock wool or glass wool into cement or other binding material has been applied to surfaces of steel-frame constructions.

However, there are problems that such a refractory thermal insulation material is poor in thermal insulation while being excellent in thermal stability of it own and pollutant such as rock wool dispersed in fine particles may be absorbed in a human body thereby causing fatal damage.

Therefore, a novel structure and material as the insulation material has been requested.

Recently, the foam glass is gaining interest due to such problems. The foam glass means a glass having a foam structure within the glass. The foam glass has properties including noncombustibility, chemical resistance, thermal insulation, lightness and manufacturing property by adding the properties due to the foam structure to the natural properties of the glass. Here, the noncombustibility and chemical resistance are the natural properties, and thermal insulation, lightness and manufacturing property are obtained from foaming the glass.

Also, the foam glass is also called as porous glass, porous electric glass or multicelluar glass indicating that the foam glass can be manufactured into various forms having a number isolated gas spaces within the glass.

The foam glass is being widely used as the optimal application of a thermal insulation material, a cold insulation material or a corrosion resistant material in use for petrochemical plants, LNG liquefied gas tank bottoms, vessels and the like, and the produced amount thereof is also increasing.

A method which has been used for producing the foam glass is briefly described as follows:

A glass is smashed into glass powder which is mixed with several kinds of expensive foaming agents. Glass powder mixed with the foaming agents is injected to a refractory mold into a certain shape and heated at a temperature higher than the softening temperature to enclose gas generated from the foaming agent.

However, such a method of the related art has problems that a manufacturing process thereof is complicated and a uniform foaming is hardly ensured.

Since gas is not uniformly generated from the foaming agents but only from within locally molten glass, a uniform foaming across the overall volume is hardly ensured.

In other words, various kinds of expensive foaming agents have been used in a process of producing the foaming glass in the related art as follows: (1) the foaming agents are surrounded by softened glass powder; (2) in which the foaming agents are necessarily in such a state that cannot contact with the ambient air, and (3) the foaming agents oxidize by depriving oxygen off the oxygen supplying components and converted into gas to form closed pores if further heated.

As above, in the process of manufacturing the foam glass for the thermal insulation material of the related art, silica sand or waste glass is finely smashed into powder, powder is mixed and stirred with the foaming agent, and a mixture thereof is calcined in the mold into a certain shape. Then, the foam glass swells as the foaming agent expands due to gas generation at the point where silica sand or waste glass powder is softened.

Besides, methods of manufacturing the foam glass are disclosed in Japanese Laid Open Patent Application H2-289435, H1-252541, S62-119123, etc. according to a sol-gel method using metal alkoxide, in which silica powder is applied after hydrolyzing ethyl silicate to form sol, which is then gelled as containing a large amount of size controlled bubbles, and then dry gel is formed and calcined.

### SUMMARY OF THE INVENTION

The present invention is proposed to solve the foregoing problems and it is therefore an object of the invention to provide a method of producing foam glass for refractory thermal insulation material which can be obtained in the minimum process and inexpensive cost while being uniformly foamed and finely shaped by causing silica gel to absorb a suitable amount of moisture.

It is another object of the invention to provide a method of producing foam glass for refractory insulation material which is environment-friendly as being composed of pure silica sand and excellent in thermal insulation as having a number of closed fine pores within particles.

It is further object of the invention to provided a foam glass for refractory insulation material which is uniformly foamed and finely shaped as being manufactured according to the foregoing method of manufacturing the foam glass.

According to the first embodiment of the invention to obtain the foregoing objects, it is provided a method of producing foam glass for refractory thermal glass comprising the following steps of: preparing a silica gel according to a sol-gel method from alkali silicate which is obtained by fusing carbon dioxide and alkali; exposing the silica gel in the wet air to absorb a proper amount of moisture; inputting silica gel in a certain amount to a heat resistant mold(F) to be shaped; calcining the mold at a constant rate up to a temperature of 980 to 1300° C. by using a tunnel kiln or a shuttle kiln(K) to be heated at least the softening temperature of glass, whereby the silica gel is fused into a foam glass in a sol state; and cooling the fused foam glass.

According to the second embodiment of the invention to obtain the foregoing objects, it is provided a method of producing foam glass for refractory thermal glass comprising the following steps of: preparing silica gel according to a sol-gel method from alkali silicate which is obtained by fusing carbon dioxide and alkali; exposing the silica gel in the wet air to absorb a proper amount of moisture; spreading the silica gel over a flat bottom; heating the spreaded silica gel at a temperature of about 1300° C.; and cooling the fused foam glass.

According to the third embodiment of the invention to obtain the foregoing objects, it is provided a method of producing foam glass for refractory thermal glass comprising the following steps of: preparing silica gel according to a sol-gel method from alkali silicate which is obtained by fusing carbon dioxide and alkali; exposing the silica gel in the wet air to absorb a proper amount of moisture; mixing the silica gel into a glass matrix and inputting a mixture of silica glass and glass matrix into a heat resistant mold(F); calcining the mold at a constant rate up to a temperature of 980 to 1300° C. by using a tunnel kiln or a shuttle kiln(K) to be heated at least the softening temperature of glass, whereby the silica gel is fused into a foam glass in a sol state; and cooling the fused foaming glass.

### BRIEF DESCRIPTION OF THE DRAWINGS

FIG. 1 shows a process according to a method of manufacturing foam glass of the invention;

FIG. 2 is a photograph for illustrating foam glass formed as the shape of grains according to a method of manufacturing foam glass of the invention;

FIG. 3 is another photograph for illustrating block-type foam glass according to a method of manufacturing foam glass of the invention; and

FIG. 4 is a photomicrograph in low magnification for showing a section of foam glass according to a method of manufacturing foam glass of the invention.

### DETAILED DESCRIPTION OF THE PREFERRED EMBODIMENT

Hereinafter, it will be described in detail about a method of producing foam glass for refractory thermal insulation material of the invention.

The present invention is provided to manufacture foam glass for refractory insulation material which is uniform in foaming and excellent in vacuum state by using porous silica gel for causing foaming glass for refractory insulation material to have a closed pore structure and allowing such silica gel to absorb a suitable amount of moisture.

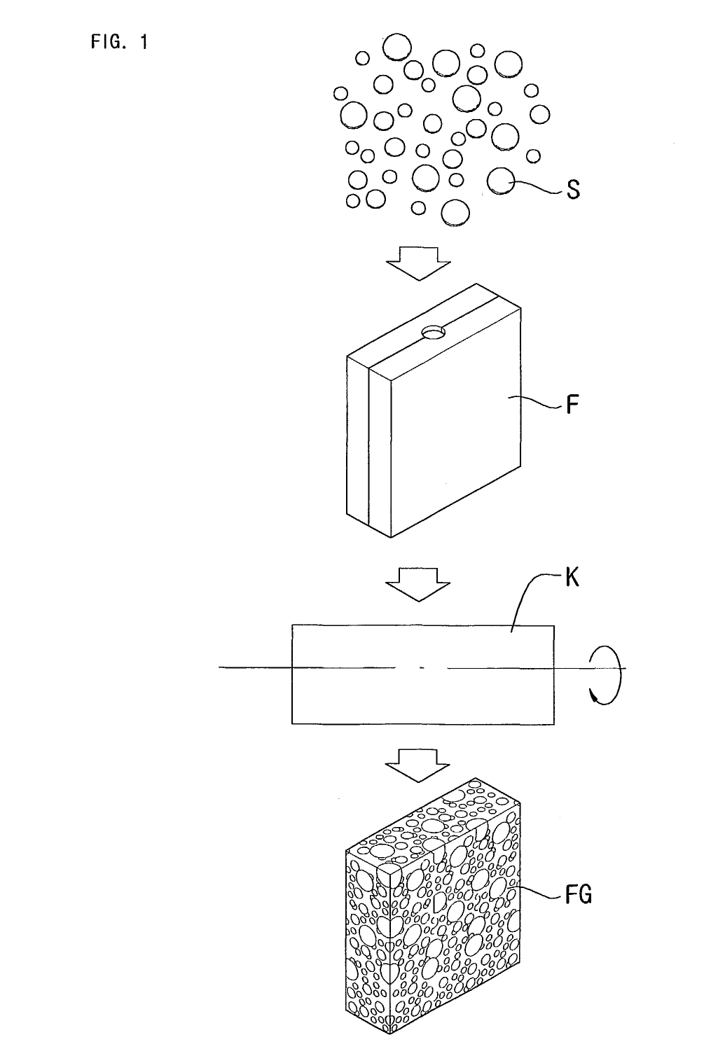

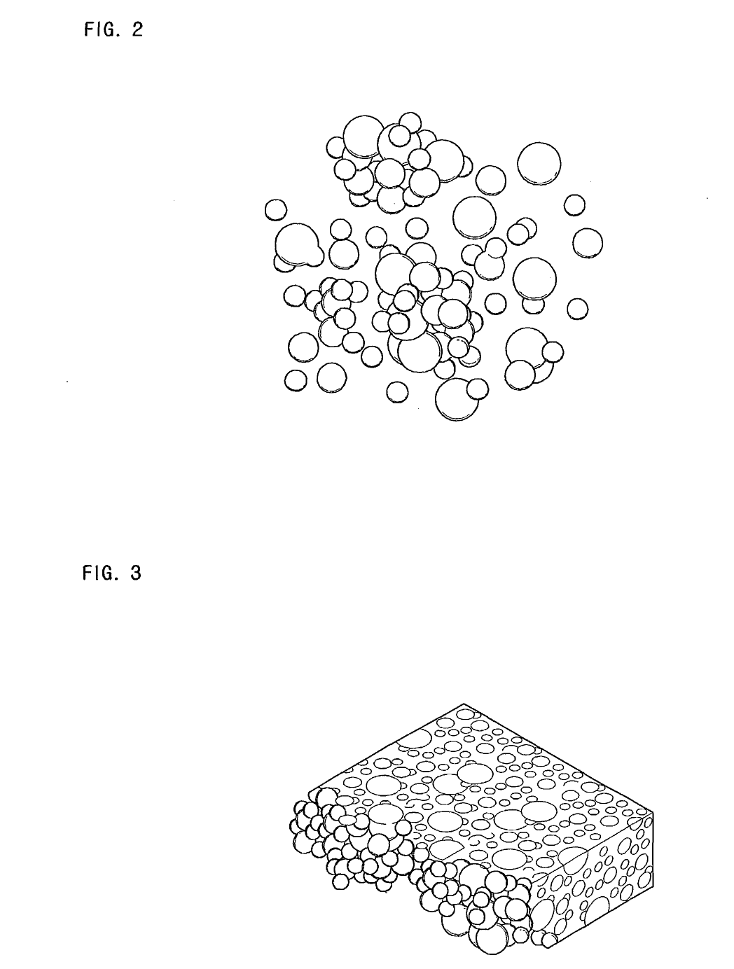

FIG. 1 shows a method of manufacturing foam glass according to the first embodiment of the invention, FIG. 2 is a photograph for illustrating foam glass formed as the shape of grains obtained by a method of manufacturing foam glass according to the second embodiment of the invention, and FIG. 3 is another photograph for illustrating block-type foam glass obtained by a method of manufacturing foam glass according to the third embodiment of the invention.

The method of manufacturing foam glass for refractory thermal insulation material of the invention has the most prominent technical feature in employing porous particles as a foaming agent and using silica gel as a preferred embodiment of the porous particles.

Porous and translucent gel or silica gel can be produced through acid decomposition of water glass. Such silica gel is gel of silica having strong absorptive power and composition of SiO₂.nH₂O which is colorless or yellowish brown and transparent or translucent powder.

Also, silica gel is applied in removing moisture in the air, extracting benzene from coal gas, extracting hydrocarbon with low melting point from natural gas, and the like.

Therefore, in order to apply silica gel as a preferred foaming agent in the invention, porous particles of silica gel containing a certain amount of moisture is prepared by using a sol-gel method. Then, silica gel is inputted into a heat resisting mold and then heated up to a temperature at least the softening temperature of glass. As glass is softened due to the heating, gas in the porous internal structure simultaneously expands and forms foam glass grains of a closed pore structure.

Meanwhile, as the second embodiment, when porous particles of moisture absorbed silica gel are spreaded over the bottom and heated at least the softening temperature, gas in the porous internal structure expands simultaneously as glass is softened, so that foam glass grains can be produced having the closed pore structure shaped as beads.

Since inside pore surface area of silica gel is about 150,000 times of outside surface area, gas or liquid absorbed in the inside of silica gel does not leak out completely from silica gel even at the softening temperature thereof in heating and surrounds the pores due to the surface softening of silica gel to intercept the same from the outside air.

Porous silica particle (silica gel) is heated up to 980 to 1300° C. at a constant rate according to the above method so that foam glass shaped as a grain or convex plate can be produced.

As the third embodiment of the invention, foam glass can be produced by mixing porous silica gel particles as a foaming agent and a glass matrix, inputting a mixture thereof into a heat resistant mold, and then calcining the mixture at 980 to 1300° C. by using a tunnel kiln or a shuttle kiln to be foamed.

A process of producing foaming glass for thermal insulation material according to the first embodiment of the invention will be described according to the following steps.

(1) First, silica gel is prepared according to a sol-gel method from alkali silicate which is obtained by fusing silicon dioxide and alkali. Silica gel can be prepared in several ways according to the combining ratio of Na₂O and SiO₂, in which the ratio of inside pore surface area to outside surface is adjusted, and the foaming rate can be adjusted according to dryness (or amount of absorbed moisture).

(2) Above silica gel(S) is exposed in the wet air to absorb a proper amount of moisture. Here, since a large amount of absorbed moisture incurs a large amount of foaming, the amount of absorbing moisture can be adjusted to regulate the foaming rate.

(3) A certain amount of silica gel(S) is inputted into a heat resistant mold(F) to have a shape.

(4) The mold is calcined at a constant rate to a temperature of 980 to 1300° C. by using a tunnel kiln or a shuttle kiln(K) and thus heated up to a temperature at least the softening temperature of glass. Here, at the softening point of glass, moisture absorbed in the porous internal structure partially escapes, and remaining moisture and gas expand to form closed porous structure.

(5) Silica gel is fused into sol state foam glass due to the above successive heating. This manufacturing method uses the natural features of an absorbent that gel is softened and abruptly expands to be foamed at a certain temperature when externally absorbed moisture fails to escape from gel and is expanded due to vaporization.

(6) If such fused foam glass is cooled, the cooling is shifted from the outside to the inside so that the pores can maintain a low vacuum state thereby having an excellent thermal insulation effect.

A result of gas amount analysis about foam glass for refractory thermal insulation material of the invention obtained the foregoing method is shown as follows. In other words, components of gas residing in silica gel after foaming and contents thereof are as follows:

moisture: 63.8%, nitrogen: 28.1%, oxygen: 7.5%, argon: 0.3%, carbon dioxide: 0.04%,

internal pressure after foaming: 204 mdar/mL (degree of relative expansion uncertainty 10%)

As can be seen in the result like this, foam glass of the invention is excellent in thermal insulation and corrosion resistance due to a number of pores provided thereto in a low vacuum state.

A method of producing foam glass for refractory thermal insulating material according to the second embodiment of the invention will be described according to the following steps:

(1) First, alkali silicate obtained by fusing silicon dioxide and alkali is processed according to a sol-gel method to prepare silica gel.

(2) Above silica gel(S) is exposed in the wet air to absorb a proper amount of moisture. Here, since a large amount of absorbed moisture incurs a large amount of foaming, the amount of absorbing moisture can be adjusted to regulate the foaming rate.

(3) Silica gel is spreaded over a flat bottom.

(4) Spreaded silica gel is heated at a rate of 20° C./min up to a temperature of 1,300° C. Here, as glass is softened due to the heating, gas in the porous internal structure simultaneously expands and forms foam glass grains of a bead-shaped closed pore structure without adhering.

(5) If such fused foam glass is cooled, the cooling is shifted from the outside to the inside so that the pores can maintain a low vacuum state thereby having an excellent thermal insulation effect.

Also, a method of producing foam glass for refractory thermal insulation material according to the third embodiment of the invention is the same as that according to the first embodiment except for inputting glass matrix into the mold after mixing with porous silica gel. Here, the glass matrix acts as a binder to enhance the overall strength in completing foam glass.

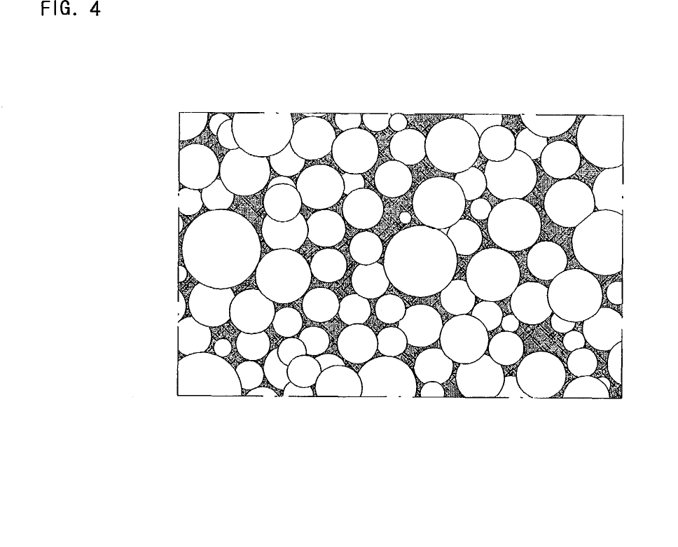

FIG. 4 is a photomicrograph in low magnification for showing a section of foam glass which has a number of closed micropores inside thereof thereby having very high thermal insulation.

As described hereinbefore, foam glass produced according to the method of the invention is environment-friendly as being composed of pure silica sand of at least 98% and excellent in thermal insulation as having a number of closed fine pores within particles with each of the pores forming a vacuum state, and provides the optimal physical properties as a thermal insulation material, a cold insulation material or a corrosion resistant material in use for semiconductor equipments, surface finish of steel-frame constructions, petrochemical plants, LNG liquefied gas tank bottoms, vessels and the like.

The method of producing foam glass according to the invention described hereinbefore is available to obtain foam glass excellent in physical properties such as uniform and fine thermal insulation by proposing the optical forming methods and conditions in which silica gel is used as a foaming agent.

What is claimed is:

1. A method of producing foam glass for refractory thermal glass comprising following the steps of:
preparing a silica gel according to a sol-gel method from alkali silicate which is obtained by fusing carbon dioxide and alkali;
exposing the silica gel in the wet air to absorb a proper amount of moisture;
inputting silica gel in a certain amount to a heat resistant mold(F) to be shaped;
calcining the mold at a constant rate up to a temperature of 980 to 1300° C. by using a tunnel kiln or a shuttle kiln(K) to be heated at least the softening temperature of glass, whereby the silica gel is fused into a foam glass in a sol state; and
cooling the fused foam glass.

2. A method of producing foam glass for refractory thermal glass comprising the following steps of:
preparing silica gel according to a sol-gel method from alkali silicate which is obtained by fusing carbon dioxide and alkali;
exposing the silica gel in the wet air to absorb a proper amount of moisture;
spreading the silica gel over a flat bottom;
heating the spreaded silica gel at a temperature of about 1300° C.; and
cooling the fused foam glass.

3. A method of producing foam glass for refractory thermal glass comprising the following steps of:
preparing silica gel according to a sol-gel method from alkali silicate which is obtained by fusing carbon dioxide and alkali;
exposing the silica gel in the wet air to absorb a proper amount of moisture;
mixing the silica gel into a glass matrix and inputting a mixture of silica glass and glass matrix into a heat resistant mold(F);
calcining the mold at a constant rate up to a temperature of 980 to 1300° C. by using a tunnel kiln or a shuttle kiln(K) to be heated at least the softening temperature of glass, whereby the silica gel is fused into a foam glass in a sol state; and
cooling the fused foaming glass.

4. The method of producing foam glass for refractory thermal glass according to one of the foregoing claims 1 to 3, wherein the ratio of inside pore area to outside pore area of the silica gel is adjusted in said step of preparing a silica gel.

5. The method of producing foam glass for refractory thermal glass according to one of the foregoing claims 1 to 3, wherein the amount of absorbed moisture is adjusted to adjust the foaming rate of the silica gel in said step of exposing the silica gel.
